(19) United States
(12) Patent Application Publication
(10) Pub. No.: US 2016/0320480 A1
(43) Pub. Date: Nov. 3, 2016

(54) DETECTION SYSTEM FOR MOUNTING ON A CORNER OF A VEHICLE

(71) Applicant: Robert Bosch GmbH, Stuttgart (DE)

(72) Inventors: Oliver Schwindt, Novi, MI (US); Kevin Buckner, Macomb, MI (US)

(21) Appl. No.: 14/702,638

(22) Filed: May 1, 2015

(51) Int. Cl. G01S 13/93; G01S 13/87; H01Q 21/00; H01Q 1/32; H01Q 9/04

(52) U.S. Cl. CPC G01S 13/931; H01Q 1/3283; H01Q 9/0407; H01Q 21/00; G01S 13/87; G01S 2013/9371

(57) ABSTRACT

Detection systems for detecting adjacent vehicles and objects around a vehicle including two faces and configured to be secured to a corner of a vehicle. A first antenna face associated with a first antenna is supported by a housing. A second antenna face associated with a second antenna is supported by the housing. An external side of the second antenna face is positioned at a reflex angle with respect to an external side of the first antenna face. The first antenna and the second antenna can be controlled by an electronic control unit that transmits adjacent vehicle and object information detected by the first antenna and the second antenna to other control systems in the vehicle.

### BACKGROUND

Embodiments of the present invention relate to systems and methods for detecting vehicles and objects in the proximity of a host vehicle.

### SUMMARY

Vehicles are commonly equipped with sensors, such as radar systems, that are used to detect other vehicles and other objects located around a vehicle. When sensors are positioned toward the rear of the vehicle, the sensors cannot detect other vehicles and objects located around a complete perimeter of vehicle. Furthermore, adjusting a position of the sensors to detect objects closer to a front of a vehicle often reduces the ability of the sensors to detect objects closer to the rear of the vehicle. Furthermore, adding sensors to a vehicle increases the cost and complexity of the vehicle.

In one embodiment, the invention provides a detection system including a housing configured to be secured to a corner of a vehicle. A first antenna face associated with a first antenna is supported by the housing. A second antenna face associated with a second antenna is also supported by the housing. The external side of the second antenna face is positioned at a reflex angle with respect to an external side of the first antenna face.

In another embodiment, the invention provides a detection system including a housing configured to be secured to a corner of a vehicle. A first antenna face associated with a first antenna is supported by the housing. A second antenna face associated with a second antenna is supported by the housing. An external side of the second antenna face is positioned at a reflex angle with respect to an external side of the first antenna face. The detection system also includes an electronic control unit configured to receive signals from the first antenna and the second antenna. The signals represent an object detected around the vehicle and the first antenna and the second antenna output a signal to a vehicle controller providing information regarding the object.

Other aspects of the invention will become apparent by consideration of the detailed description and accompanying drawings.

### BRIEF DESCRIPTION OF THE DRAWINGS

FIGS. 1A-1C illustrate a detection system.

FIG. 2A illustrates an embodiment of a detection system with two faces.

FIG. 2B illustrates an embodiment of one face of the detection system of FIG. 2A.

FIGS. 3 and 4 schematically illustrate a control system included in the detection system of FIG. 2A.

FIGS. 5A-5C illustrate fields-of-view of the detection system of FIG. 2A secured to corners of a host vehicle.

FIG. 6 illustrates the detection system of FIG. 2A secured to four corners of a host vehicle.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

It should be noted that a plurality of hardware and software based devices, as well as a plurality of different structural components may be used to implement the invention. In addition, it should be understood that embodiments of the invention may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic based aspects of the invention may be implemented in software (e.g., stored on non-transitory computer-readable medium) executable by one or more processors. As such, it should be noted that a plurality of hardware and software based devices, as well as a plurality of different structural components may be utilized to implement the invention. For example, “control units” and “controllers” described in the specification can include one or more processors, one or more memory modules including non-transitory computer-readable medium, one or more input/output interfaces, and various connections (e.g., a system bus) connecting the components.

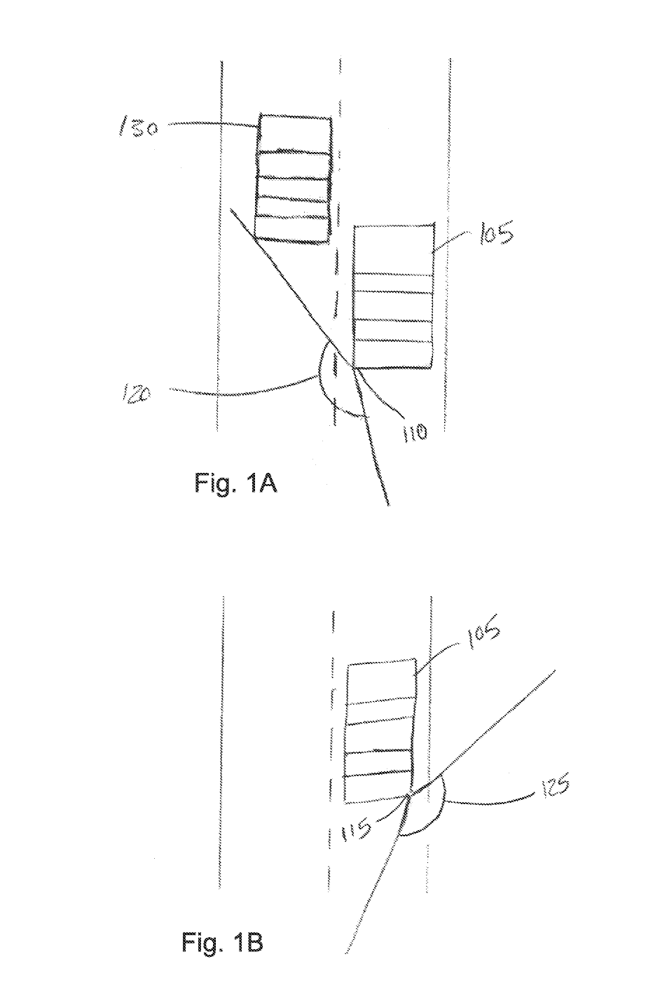

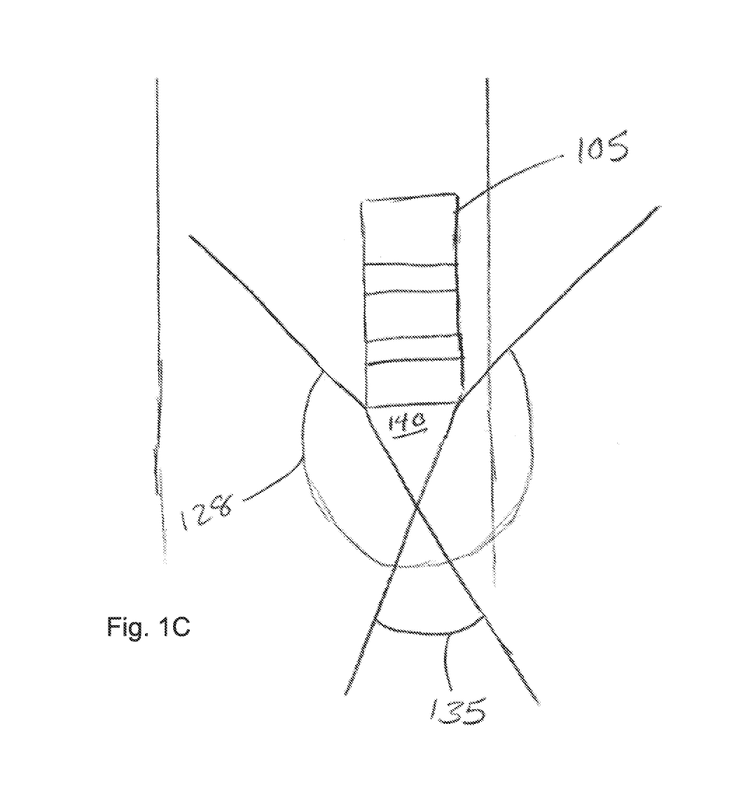

FIG. 1A illustrates a detection system 100 secured to a host vehicle 105. The detection system 100 includes a left-rear antenna 110. The left-rear antenna 110 has a field-of-view 120 that extends from the driver's side of the host vehicle 105 to the rear of the host vehicle 105. However, as illustrated, in some situations, the field-of-view 120 does not cover a second vehicle 130 in a lane adjacent to a host vehicle 105. Therefore, the detection system 100 cannot detect the second vehicle 130 when the second vehicle 130 is located forward of the field-of-view 120.

As illustrated in FIG. 1B, the detection system 100 can also include a right-rear antenna 115. The right-rear antenna 115 has a field-of-view 125 that extends from the passenger's side of the host vehicle 105 to the rear of the host vehicle 105. As illustrated, in some embodiments, the field-of-view 125 does not cover a forward, passenger-side of the host vehicle 105 and, hence, cannot detect vehicles or other objects located in this area around the vehicle.

FIG. 1C illustrates a combined field-of-view 128 of the left-rear antenna 110 and the right-rear antenna 115. In some applications, the combined field-of-view 128 is adequate to make a driver aware of other vehicles around the host vehicle 105. However, in other applications, such as automated vehicle maneuvering (e.g., automatic lane changes and lane change assistance), the combined field-of-view 128 is inadequate. Also, although the field-of-view 120 can be extended forward of the host vehicle 105 (e.g., to cover the second vehicle 130 illustrated in FIG. 1A) by adjusting the position of the left-rear antenna 110, extending the field-of-view 120 in one direction reduces the coverage of the field-of-view 120 in the opposite direction. For example, as illustrated in FIG. 1C, if the field-of-view 120 is rotated to point more forward to cover the second vehicle 130, an overlapping field-of-view 135 included in the combined field-of-view 128 is reduced. Similarly, as the field-of-view 125 is extended forward, the overlapping field-of-view 135 is reduced. As the overlapping field-of-view 135 is reduced, the larger a rear blind spot 140 of the detection system 100. The larger the rear blind spot 140, the more likely the detection system 100 cannot detect an object close to the host vehicle 105, such as a post. Therefore, re-positioning the left-rear antenna 110 and the right-rear antenna 115 results in a trade-off between side detection and rear detection. Furthermore, increasing the number of sensors on the host vehicle 105 to extend the detection range of the detection system 100 increases cost and complexity.

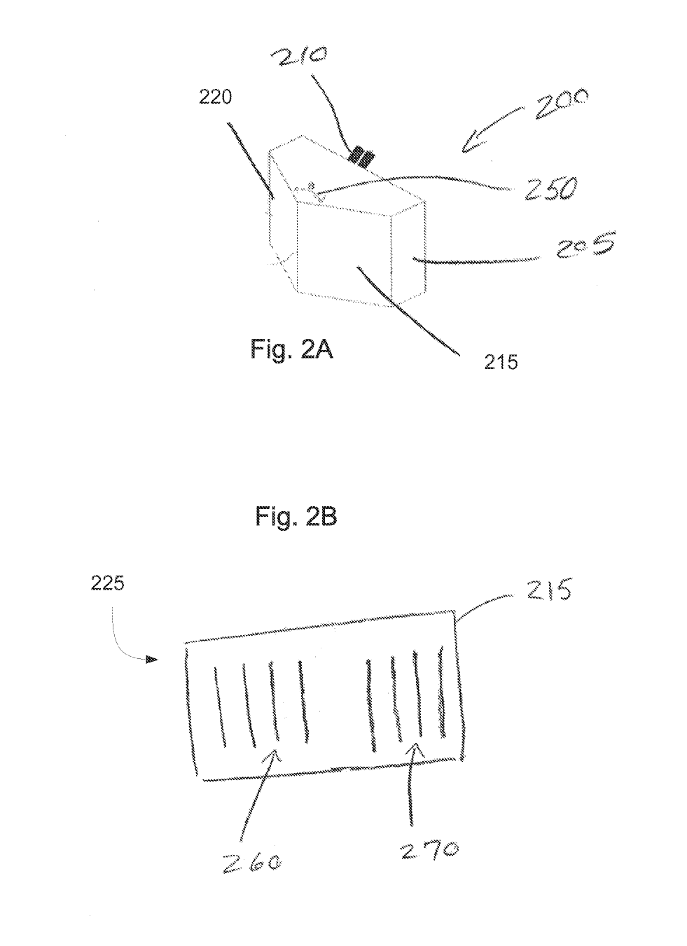

To solve these and other problems, embodiments of the invention provide a detection system with two faces and methods for operating the same. FIG. 2A illustrates a detection system with two faces 200. The detection system 200 includes a housing 205. The housing 205 is configured to be secured to one or more locations on a vehicle using standard securing techniques (e.g., bolts, bonding materials, etc.). In particular, as described below, the housing 205 can be configured to be secured to a corner of a vehicle.

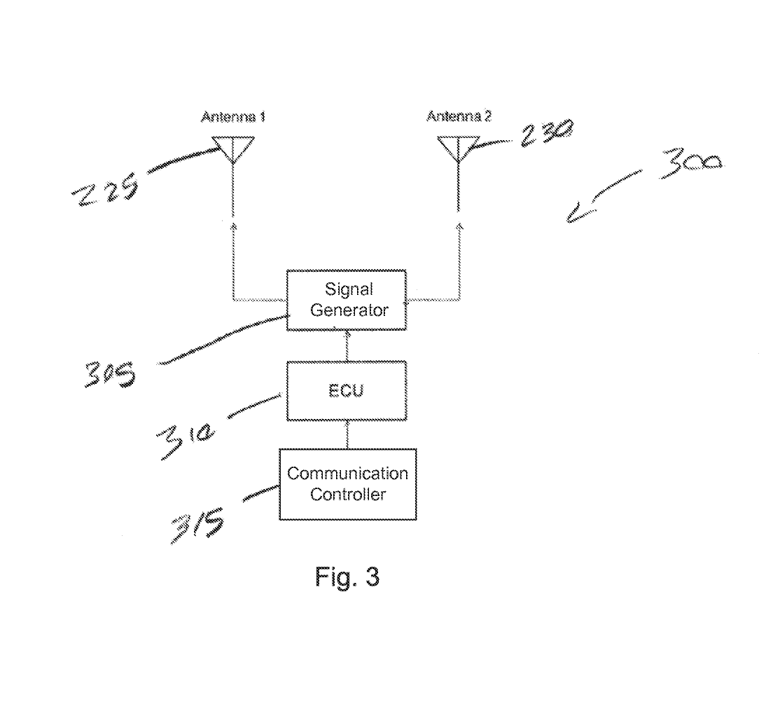

The housing 205 supports a first antenna face 215 and a second antenna face 220. In some embodiments, the housing 205 is formed as one or more manufactured pieces including the first antenna face 215 and the second antenna face 220. Alternatively, the first antenna face 215 and the second antenna face 220 can be formed as a layer (e.g., a contiguous layer) that is overlaid on and supported by the housing 205. The first antenna face 215 is associated with a first antenna 225, and the second antenna face 220 is associated with a second antenna 230 (see FIG. 3). In one embodiment, one or both of the first antenna 225 and the second antenna 230 are planar antennas. For example, in the embodiment illustrated in FIG. 2B, the first antenna face 215 includes a first antenna 225 that includes a plurality of generating elements 260 and a plurality of receiving elements 270. The generating elements 260 transmit signal pulses from the first antenna face 215, and the receiving elements 270 receive reflections of the signal pulses. The plurality of generating elements 260 and the plurality of receiving elements 270 are positioned within or on the surface of the first antenna face 215. The plurality of generating elements 260 and the plurality of receiving elements 270 can be printed on a surface of the first antenna face 215 either on the outside or the inside of the first antenna face 215. In other embodiments, rather than being printed on the first antenna face 215, the plurality of generating elements 260 and the plurality of receiving elements 270 are positioned inside the housing 205 and located behind the first antenna face 215. The generating elements 260 and the receiving elements 270 are aligned with the first antenna face 215 such that the fields-of-view described herein are realized. Similarly, the second antenna face 220 can also include a plurality of generating elements 260 and a plurality of receiving elements 270. As described below, in some embodiments, the first antenna face 215 and the second antenna face 220 can use radar to detect objects. Therefore, in these configurations, the generating elements 260 can include radar-generating elements and the receiving elements 270 can include radar-receiving elements. It should also be understood that in some embodiments, each antenna face can include multiple antennas with independent generating elements and receiving elements.

The first antenna face 215 is positioned adjacent to the second antenna face 220. In particular, as illustrated in FIG. 2A, the first antenna face 215 and the second antenna face 220 are positioned such that a reflex angle is formed between an external side of the first antenna face 215 and an external side of the second antenna face 220. Correspondingly, an internal side of the first antenna face 215 and an internal side of the second antenna face 220 form an obtuse angle 250 of approximately 130 degrees. The obtuse angle 250 determines a size of a combined field-of-view of the first antenna 225 and the second antenna 230. In other words, a smaller obtuse angle results in a larger reflex angle and therefore, a larger field-of-view.

FIG. 3 illustrates a controller 300 for the detection system 200. The controller 300 can be connected to a connector 210 that connects the controller 300 to the first antenna 225 and the second antenna 230. In some embodiments, the connector 210 is formed in the housing 205. As illustrated in FIG. 3, the controller 300 includes a signal generator 305 and an electronic control unit (“ECU”) 310. The signal generator 305 communicates with the first antenna 225 and the second antenna 230. In particular, the signal generator 305 can include circuitry for generating and transmitting signals (e.g., voltage pulses) to the first antenna 225 and the second antenna 230. In some embodiments, the signal generator 305 is configured to generate signals that differ in amplitude and frequency depending on a control signal received from the ECU 310. The signal generator 305 can also be configured to receive signals (e.g., voltage pulses) from the antennas 225 and 230. These signals can correspond to reflected signals detected by the antennas 225 and 230 representing objects within the antennas fields-of-view. For example, in some embodiments, the signal generator 305 can be configured to convert the received signals into signals indicating a position and/or a speed of a detected object. Regardless of whether the signal generator 305 processes the received signal, the signal generator 305 can be configured to send the signals received from the antennas 225 and 230 to the ECU 310.

In some embodiments, the signal generator 305 includes a radar signal generator. Accordingly, in these embodiments, the first antenna 225 and the second antenna 230 transmit the voltage pulses received from the signal generator 305 as radar signals and the signal generator receives voltage pulses from the first antenna 225 and the second antenna 230 based on reflected radar signals detected by the first antenna 225 and the second antenna 230. However, it should be understood that in addition to or as an alternative to using radar signals, the detection system 200 can use other types of signals for detecting objects located around a vehicle, including ultrasonic signals, light (ultraviolet, visible, near-infrared, infrared, etc.) signals, etc.

The ECU 310 communicates with one or more vehicle controllers either directly or over a network. For example, in some embodiments, the ECU 310 is connected to a communication controller 315, such as a controller area network (“CAN”) controller. The communication controller 315 is connected to network, such as a CAN bus, which connects to one or more vehicle controllers. It should be understood that the ECU 310 can be configured to connect to other types of vehicle communication networks or buses in addition to or as an alternative to a CAN bus, including a local interconnect network (“LIN”), an Ethernet bus, etc. Also, in some embodiments, the functionality of the communication controller 315 is performed by the ECU 310 (e.g., the ECU 310 includes an interface to a vehicle communication network).

The ECU 310 receives and analyzes signals received from the signal generator 305 and, based on the analyzed signals, provides information (e.g., on the CAN bus through the communication controller 315) regarding objects detected around the vehicle (e.g., position, speed, classification, etc.).

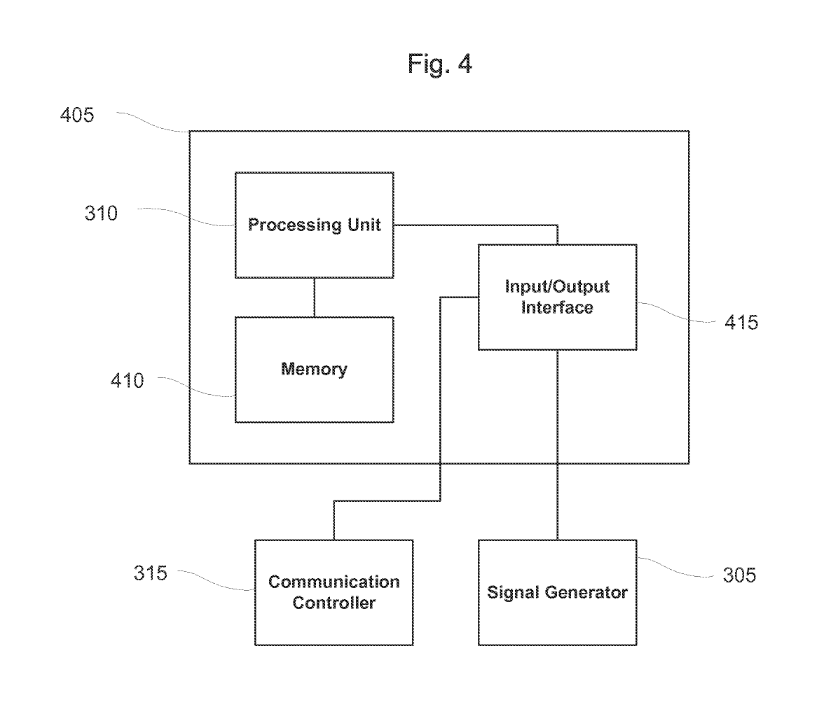

The ECU 310 includes a plurality of electrical and electronic components that provide power, operational control, and protection to the components within the ECU 310. In particular, as illustrated in FIG. 4, the ECU 310 includes a processing unit 405 (e.g., a microprocessor or another suitable programmable device), a memory 410, and an input/output interface 415. The processing units 405, the memory 410, and the input/output interface 415 are connected by one or more control or data buses. It should be understood that the ECU 310 can include other components than those illustrated in FIG. 4. Furthermore, in some embodiments, the ECU 310 can include multiple processing units, multiple memories, multiple input/output interfaces, or a combination thereof. Also, in some embodiments, the functionality performed by the ECU 310 as described in the present application is distributed among multiple ECUs.

The memory 410 includes a program storage area and a data storage area. The program storage area and the data storage area can include combinations of different types of non-transitory memory (i.e., computer-readable medium), such as read-only memory (“ROM”) and random access memory (“RAM”). The processing unit 405 is connected to the memory 410 and fetches and executes instructions stored in the memory 410. As noted above, the instructions executed by the processing unit 405 can include instructions for exchanging information with the signal generator 305 and the communication controller 315 and processing information received from the signal generator 305 and the communication controller 315.

For example, the instructions can include instructions for controlling the signal generator 305, and, consequently, controlling the transmission of signals. In some embodiments, the first antenna 225 is configured to transmit a signal designed or optimized to detect objects in a near field (i.e., short-range), and the second antenna 230 is configured to transmit a signal that detects objects in a medium field (i.e., medium-range). This configuration can allow the ECU 310 to determine (1) whether a lane adjacent to a vehicle is clear through the first antenna 225 and (2) whether any objects, such as other vehicles, are rapidly approaching the vehicle through the second antenna 230, which has a further detection range. It should be understood that even if an antenna is configured with a medium range, the antenna can still detect objects close to the vehicle, such as posts, shopping carts, people, and animals.

As noted above, the ECU 310 can be configured to detect objects based on signals received form the signal generator 305. The ECU can also be configured to determine a position and a speed (e.g., relative to the vehicle) of detected objects. Furthermore, in some embodiments, the ECU 310 is configured to classify objects detected around a vehicle (e.g., post, vehicle, stationary object, person, etc.). The ECU 310 transmits all of this information to the communication controller 315. The communication controller 315 can be configured to forward the information to the CAN bus, where it can be used by other vehicle controllers (e.g., controllers performing automatic maneuvers). In some embodiments, the communication controller 315 is also configured to process the information received from the ECU310. For example, the communication controller 315 can be configured to perform all or a portion of the processing described above for the ECU 310 (e.g., object detection, position and speed determination, and/or object classification). Also, in some embodiments, the communication controller 315 can be configured to process the information received form the ECU 310 to determine whether a situation exists that other vehicle controllers should be alerted of. For example, if the information from the ECU 310 indicates that no objects have been detected around the vehicle, the communication controller 315 can be configured to not transmit information on the CAN bus or transmit an “ALL CLEAR” or similar message on the CAN bus. Alternatively, if an object has been detected, the communication controller 315 can transmit a message on the CAN bus providing information regarding the detected object and/or any hazardous situations associated with the detected object (e.g., position, speed, classification, or a combination thereof). The vehicle controllers receiving the messages can react to the message in various ways, including but not limited to activating braking systems, generating blind-spot warning systems, prefilling braking systems, and activating other alerts and safety systems.

It should be understood that, in some embodiments, the first antenna 225 and the second antenna 230 are each associated with a dedicated control unit as described above (e.g., the ECU 310). Similarly, in some embodiments, the first antenna 225 and the second antenna 230 can be associated with a dedicated signal generator, which are controlled by the same control unit (e.g., the ECU 310). In still other embodiments, the functionality of the signal generator 305 can be combined with the ECU 310.

The detection system 200 can be secured to a corner of a vehicle. In particular, the reflex angle formed between the external side of the first antenna face 215 and the second antenna face 220 makes the detection system 200 shaped for installation on a corner of a vehicle. For example, the corner (e.g., rear corner) of a vehicle can have a first surface or curve that generally aligns with the first antenna face 215 and a second surface or curve that generally aligns with the second antenna face 220.

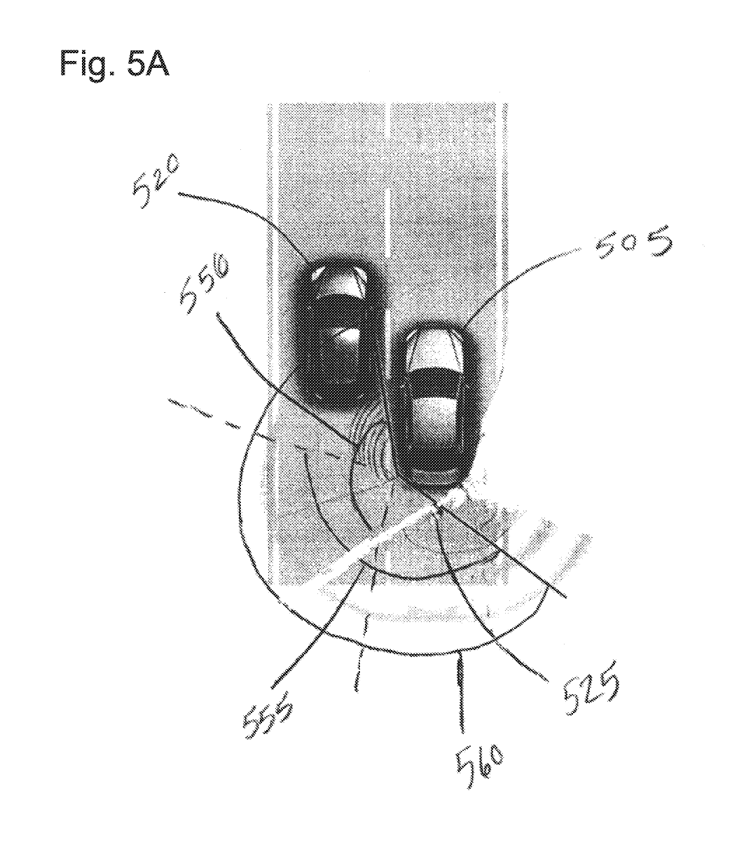

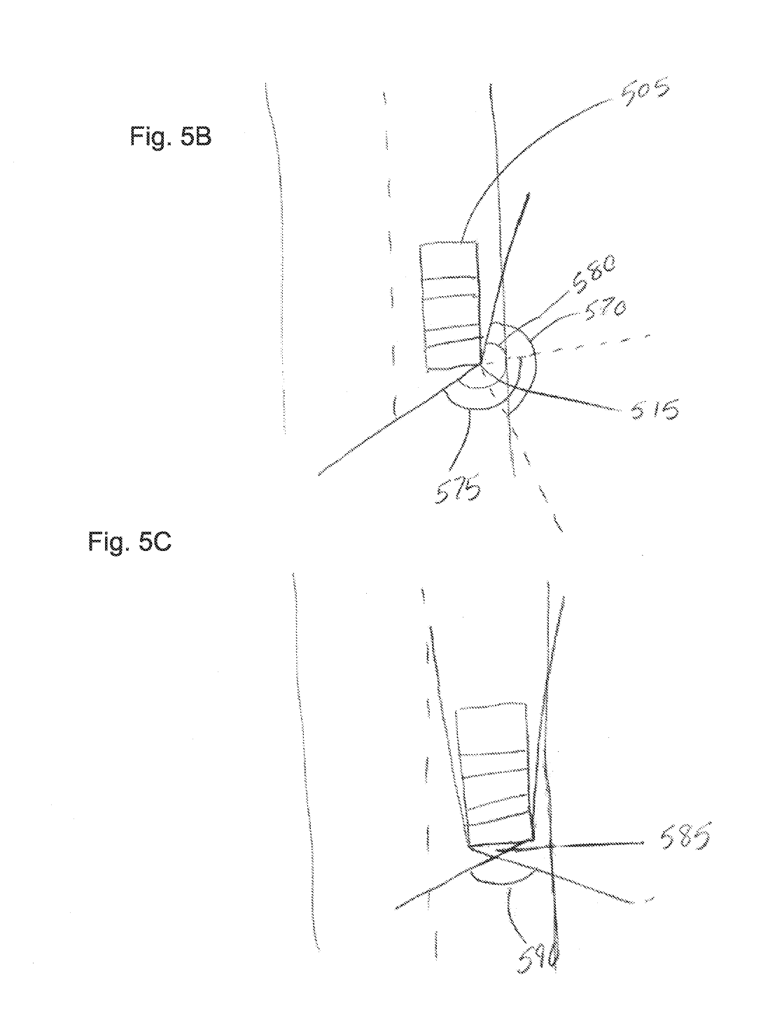

For example, FIG. 5A illustrates the detection system 200 secured to a host vehicle 505. In particular, as illustrated, the detection system 200 is secured to a left-rear corner of the host vehicle 505. When secured to the host vehicle 505 at this location, the first antenna face 215 is positioned at a small angle (e.g., approximately 20 degrees) from a plane parallel to a side length of the host vehicle 505. This position of the first antenna face 215 creates a field-of-view 550 of approximately 150 degrees, which covers a lane adjacent to the driver side of the host vehicle 505. Accordingly, the first antenna 225 can detect a second vehicle 520 adjacent to and forward from the host vehicle 505 that the system 100 described above could not detect.

As illustrated in FIG. 5A, the second antenna face 220 is positioned at a small angle (e.g., approximately 20 degrees) from a plane parallel to a rear width of the host vehicle 505. This position of the second antenna face 220 establishes a field-of-view 555 of approximately 150 degrees, which covers an area behind the host vehicle 505. Accordingly, the second antenna 230 can detect an object 525 positioned directly behind the host vehicle 505.

As illustrated in FIG. 5A, the first antenna face 215 and the second antenna face 220 create a combined field-of-view 560 of approximately 200 degrees. The combined field-of-view 560 covers a wide portion of the adjacent lane and the rear of the host vehicle 505. The obtuse angle 250 between the first antenna face 215 and the second antenna face 220 can be adjusted to achieve a different spread to the field-of-view 560. In general, the wider the spread of the field-of-view 560, the more information the detection system 200 can detect regarding the surroundings of the host vehicle 505, which can be used to perform automatic maneuvers. For example, in some embodiments, the detection system 200 can provide information to a controller included the host vehicle 505 configured to perform automatic lane change maneuvers or provide lane change assistance. In particular, using the detection system 200, a second vehicle 520 approaching the host vehicle 505 from behind or from the front can be detected earlier and, consequently, automated lane change maneuvers can be performed or aborted accordingly.

As illustrated in FIG. 5B, as an alternative to the left-position system 200 illustrated in FIG. 5A, the host vehicle 505 can include the detection system 200 secured to a right-rear corner of the host vehicle 505. The right-position system 200 can be a mirror image of the left-position system 200. In the right-position system 200, the first antenna 225 has a field-of-view 570 of approximately 150 degrees, which covers a lane adjacent to the passenger side of the host vehicle 505. The second antenna 230 has a field-of-view 575 of approximately 150 degrees, which covers the rear of the host vehicle 505. The field-of-view 570 and the field-of-view 575 form a combined field-of-view 580 of approximately 200 degrees. The obtuse angle 250 can be adjusted to widen the spread of the combined field-of-view 580. In some embodiments, the combined field-of-view 580 provides similar coverage on the passenger side as the combined field-of-view 560 provided on the driver side by the left-position system 200.

As illustrated in FIG. 5C, in some embodiments, the host vehicle 505 can include the left-position system 200 and the right-position system 200. In this embodiment, the left-position system 200 and the right-position system 200 can function independently or can work together to detect objects around the host vehicle 505. For example, the combined field-of-view 560 provided by the left-position system 200 and the combined field-of-view 580 provided by the right-position system 200 overlap to form a rear field-of-view 590. Both the left-position system 200 and the right-position system 200 can detect objects in the rear field-of-view 590.

In some applications, a blind-spot 585 directly behind the rear bumper of the host vehicle 505 is outside of the combined field-of-view 590. The blind-spot 585 can be reduced or eliminated by increasing the width of the rear field-of-view 590. Reducing or eliminating the blind-spot 585 allows the systems 200 to detect objects (e.g., poles, bollards, pedestrians, etc.) located directly behind the host vehicle 505.

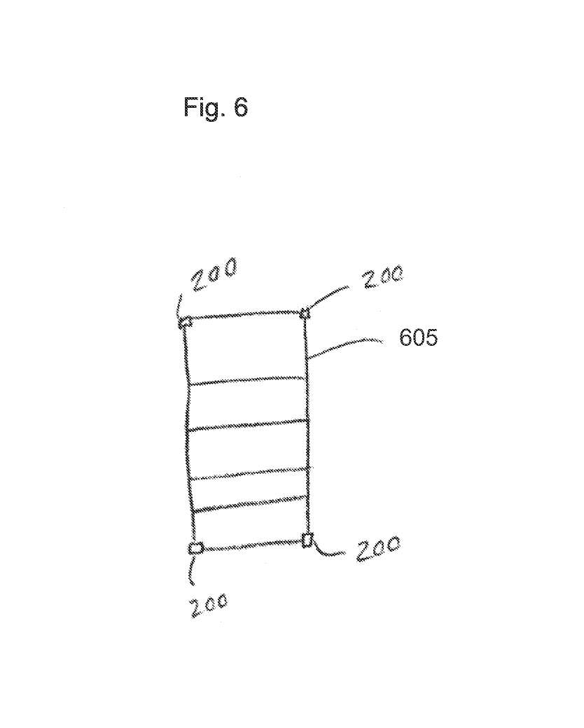

It should be understood that the detection system 200 can be positioned at various locations on a vehicle and, in some embodiments, can be secured to one or more corners of a vehicle. For example, as illustrated in FIG. 6, the detection system 200 can be secured to each of the four corners of the host vehicle 605 (e.g., a left front corner, a left rear corner, a right front corner, and a right rear corner). In such an embodiment, the fields-of-view of each detection system 200, when combined, cover approximately 360 degrees around the host vehicle 605. In this configuration, the system 200 can detect a vehicle or other objects located in front of, behind, or adjacent to the host vehicle 605. In addition, objects near to the host vehicle 605 can be detected due to overlapping fields-of-view.

Thus, embodiments of the invention provide, among other things, a detection system for a vehicle including a first antenna face supporting a first antenna and a second antenna face supporting a second antenna. An external side of the first antenna face is positioned at a reflex angle with respect to an external side of the second antenna face. The first antenna and the second antenna provide a combined field-of-view that extends in a horizontal direction to detect objects positioned around a vehicle.

Various features and advantages of the invention are set forth in the following claims.

What is claimed is:

1. A detection system comprising:
a housing configured to be secured to a vehicle;
a first antenna face associated with a first antenna, the first antenna face supported by the housing; and
a second antenna face associated with a second antenna, the second antenna face supported by the housing and an external side of the second antenna face positioned at a reflex angle with respect to an external side of the first antenna face.

2. The detection system of claim 1, wherein the first antenna face and the second antenna face are formed as a layer overlaying the housing.

3. The detection system of claim 1, wherein the first antenna face and the second antenna face are formed in the housing.

4. The detection system of claim 1, wherein the first antenna is a radar antenna and the second antenna is a radar antenna.

5. The detection system of claim 1, wherein the first antenna includes a planar antenna.

6. The detection system of claim 5, wherein the planar antenna includes a plurality of receiving elements positioned on the first antenna face.

7. The detection system of claim 5, wherein the planar antenna includes a plurality of receiving elements positioned on a surface of the first antenna face.

8. The detection system of claim 1, wherein the second antenna includes a planar antenna.

9. The detection system of claim 8, wherein the planar antenna includes a plurality of receiving elements positioned on the second antenna face.

10. The detection system of claim 8, wherein the planar antenna includes a plurality of receiving elements positioned on a surface of the second antenna face.

11. The detection system of claim 1, wherein the first antenna includes a plurality of receiving elements located inside the housing and behind the first antenna face.

12. The detection system of claim 1, wherein the second antenna includes a plurality of receiving elements located inside the housing and behind the second antenna face.

13. A detection system comprising:
a housing configured to be secured to a vehicle;
a first antenna face associated with a first antenna, the first antenna face supported by the housing;
a second antenna face associated with a second antenna, the second antenna face supported by the housing and an external side of the second antenna face positioned at a reflex angle with respect to an external side of the first antenna face; and
an electronic control unit configured to receive signals from the first antenna and the second antenna representing an object detected around the vehicle and output a signal to a vehicle controller providing information regarding the object.

14. The detection system of claim 13, further comprising a radar signal generator for transmitting signals to the first antenna and the second antenna.

15. The detection system of claim 14, wherein the electronic control unit is configured to receive the signals from the first antenna and the second antenna through the radar signal generator.

16. The detection system of claim 13, further comprising a communication controller configured to receive the signal output from the electronic control unit and transmit a message to the vehicle controller over at least one vehicle communication bus based on the signal output from the electronic control unit.

17. The detection system of claim 13, wherein the signal output from the electronic control unit provides a position and a speed relative to the vehicle of the object.

18. The detection system of claim 13, wherein the first antenna includes a first planar antenna and the second antenna includes a second planar antenna.

19. The detection system of claim 18, wherein the first planar antenna includes a first plurality of receiving elements supported by the first antenna face and the second planar antenna includes a second plurality of receiving elements supported by the second antenna face.

20. The detection system of claim 18, wherein the first planar antenna includes a first plurality of receiving elements positioned behind the first antenna face and the second planar antenna includes a second plurality of receiving elements positioned behind the second antenna face.
